(19) United States
(12) Patent Application Publication
(10) Pub. No.: US 2009/0121203 A1
(43) Pub. Date: May 14, 2009

(54) LAWN AND GARDEN EQUIPMENT LIFT

(75) Inventors: Thomas P. Martini, Blacklick, OH (US); Mark Zellefrow, Reynoldsburg, OH (US); Rodger Hays, Columbus, OH (US); Ken Hoffman, Reynoldsburg, OH (US); Fred Feeney, Grove City, OH (US); Mike Podrosky, Columbus, OH (US)

Correspondence Address: ELEY LAW FIRM CO., 7870 OLENTANGY RIVER RD, SUITE 311, COLUMBUS, OH, 43235, US

(73) Assignee: OHIO STEEL INDUSTRIES, INC., COLUMBUS, OH (US)

(21) Appl. No.: 12/267,549

(22) Filed: Nov. 7, 2008

Related U.S. Application Data
(60) Provisional application No. 60/987,023, filed on Nov. 9, 2007.
(60) Provisional application No. 61/039,815, filed on Mar. 27, 2008.
(60) Provisional application No. 61/083,536, filed on Jul. 25, 2008.

(51) Int. Cl. B66F 15/00; B66F 3/00

(52) U.S. Cl. 254/131

(57) ABSTRACT

A lifting device for a lawn tractor. An angle member has first and second generally planar portions, the second planar portion being oriented generally perpendicularly and joined to the first planar portion. A pair of wheels are rotatably attached to opposing ends of the angle member. A handle extends from the first planar portion of the angle member. A foot brace is attached to the handle and is oriented generally perpendicularly thereto; A pair of spaced-apart lift members extend from the second planar portion of the angle member. An elongated safety brace is configured to detachably couple to the foot brace. The safety brace is positionable to extend beneath the angle member while coupled to the foot brace and while the lifting device is in a service position, thereby resisting movement of the lift from the service position.

This application claims priority to U.S. provisional patent application No. 60/987,023, filed Nov. 9, 2007; U.S. provisional patent application No. 61/039,815, filed Mar. 27, 2008; and U.S. provisional patent application No. 61/083,536, filed Jul. 25, 2008, the entire contents of each application being incorporated herein by reference thereto.

### FIELD

The present invention relates generally to devices for raising and lowering equipment, in particular to devices for raising and lowering lawn and garden equipment between a use position and a service position.

### BACKGROUND

Periodic maintenance of lawn and garden equipment such as lawn tractors, garden tractors, zero-turn mowers and hand mowers (hereinafter generally termed “lawn tractors”) commonly includes such tasks as cleaning the mower deck by scraping mud and debris from under surfaces of the mower deck, and removal, sharpening and reinstallation of grass cutting rotary blades. In addition, lawn tractors often need servicing, such as for the replacement of belts, the repair and/or replacement of blades, and fixing flat tires. In order to perform such tasks the clearance between the ground and the lower surfaces of the mower must be sufficient to allow an operator to access the under surfaces of the mower deck with tools such as wrenches and scrapers. A commonly-utilized means for providing the needed ground clearance for mower deck maintenance is wheel stand ramps. However, ramps suffer from a drawback in that they may provide insufficient ground clearance for the needed access. Furthermore, ramp structures often at least partially block access to the under surfaces of the mower deck. In addition to needing an easy way to access the tractor for maintenance, it is also desirable to have a way to lift and maneuver a lawn tractor about without having to start its engine. Another desirable feature is a safety device to secure a lawn tractor when it is lifted to a service position.

### SUMMARY

A lift for a lawn tractor is disclosed according to an embodiment of the present invention. The lift comprises a set of spaced-apart, adjustable lift members coupled to a handle and oriented generally perpendicularly thereto. A set of wheels are interposed between the lift bars and the handle. In operation, the lift members are positioned underneath a jacking point of the lawn tractor. A user then pivots the handle downwardly to a generally horizontal orientation proximate the ground, causing the lift members to pivot upwardly about the wheels and raise an end of the lawn tractor to an elevated position away from the ground. A safety device may be employed to hold the lift in place, thereby resisting movement of the handle that could cause the lawn tractor to unexpectedly lower while elevated.

A lift for a lawn tractor is disclosed according to another embodiment of the present invention. The lift comprises a set of spaced-apart, adjustable lift members coupled to a handle and oriented generally perpendicularly thereto. A set of wheels are interposed between the lift bars and the handle. In operation, the lift members are positioned underneath a jacking point of the lawn tractor. A user then pivots the handle downwardly to a generally horizontal orientation proximate the ground, causing the lift members to pivot upwardly about the wheels and raise an end of the lawn tractor to an elevated position away from the ground. In the elevated position the lift rests upon a pair of support legs. A safety device may be employed to hold the lift in place, thereby resisting movement of the handle that could cause the lawn tractor to move or fall off the lift.

In some embodiments the lift may include a pair of stabilizers that are rotatably coupled to an angle bracket. The stabilizers rotate freely such that they easily fall to the ground due to the force of gravity. A corresponding pair of safety locks, which are also rotatably coupled to angle bracket, likewise hang freely towards the ground due to the force of gravity. When the lift is operated to raise a lawn tractor to a service position the stabilizers remain in contact with the ground as the angle bracket pivots about an axle. As the angle bracket pivots the safety locks move up and over a contacting surface of corresponding stabilizers, resting proximate the angle bracket. In this position, if an attempt is made to lift the handle the safety locks will engage the stabilizers to resist said lifting. When the lift is to be lowered, a user first rotates each safety lock away from the corresponding stabilizer. The safety locks are thus disengaged from the stabilizers, allowing a handle of the lift to be moved upwardly to lower the lawn tractor. As the tractor is lowered the safety locks rotate back to the starting position due to the force of gravity, thereby resetting the safety locks for engaging the stabilizers when the handle is subsequently lowered to raise a lawn tractor to a service position in the manner previously described.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 shows the general arrangement of a lift according to an embodiment of the present invention;

FIG. 2 shows several subassemblies of the lift of FIG. 1;

FIG. 3 is an exploded view showing details of the components of the lift of FIG. 1;

FIG. 4 shows the lift of FIG. 1 holding a lawn tractor in a raised position;

FIG. 5 shows example positions of mounting bars attached to a lawn tractor for use in conjunction with the lift of FIG. 1 according to an embodiment of the present invention;

FIG. 6 shows the movement of a handle portion of the lift of FIG. 1 between a storage position and a use position;

FIG. 7 shows a cross lift bar attached to a rear hitch of a lawn tractor;

FIG. 8 shows the general arrangement of a lift according to another embodiment of the present invention;

FIG. 9 is an exploded view showing details of the components and the assembly of the lift of FIG. 8;

FIG. 10 is another exploded view showing further details of the components and the assembly of the lift of FIG. 8;

FIG. 11 shows details of several components of the lift of FIG. 8;

FIG. 12 shows adjustments to the lift of FIG. 8 to accommodate various types of lawn tractors;

FIGS. 13A and 13B illustrate mounting bars attached to a lawn tractor for use in conjunction with the lift of FIG. 8 according to an embodiment of the present invention;

FIG. 14 illustrates the lift of FIG. 8 in operation;

FIG. 15 shows a tether arrangement for a receiver tube and a lift member according to an optional embodiment of the present invention;

FIG. 16 shows the general arrangement of a lift according to yet another embodiment of the present invention;

FIG. 17 is a rear elevational view of the lift of FIG. 16;

FIG. 18 is a side elevational view of the lift of FIG. 16;

FIG. 19 is a top elevational view of the lift of FIG. 16;

FIGS. 20-23 show details of a safety device for a lift according to an embodiment of the present invention; and

FIG. 24 illustrates mounting bars attachable to a lawn tractor for use in conjunction with the lifts disclosed herein, according to an embodiment of the present invention.

### DETAILED DESCRIPTION

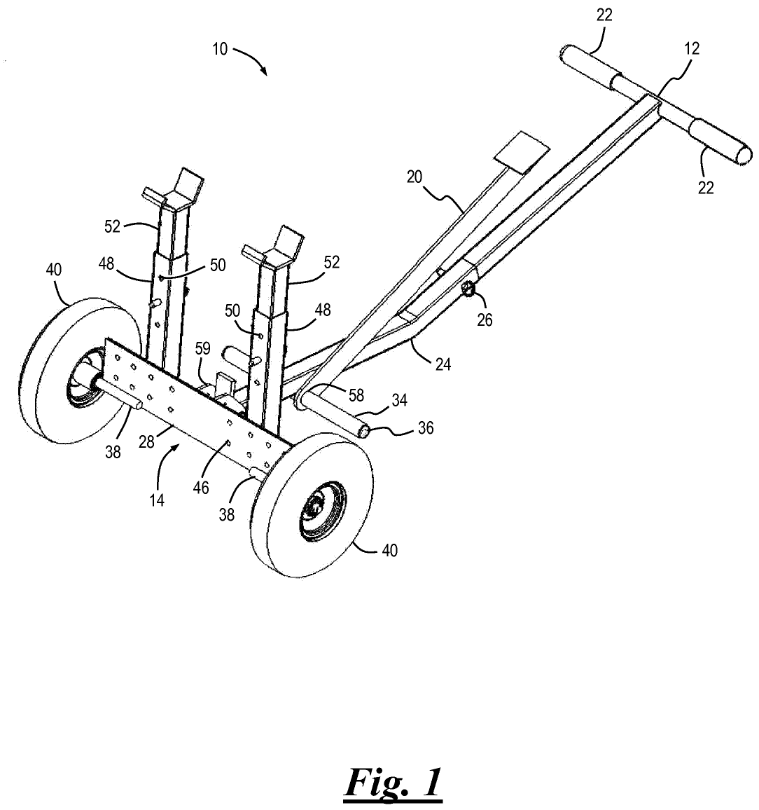

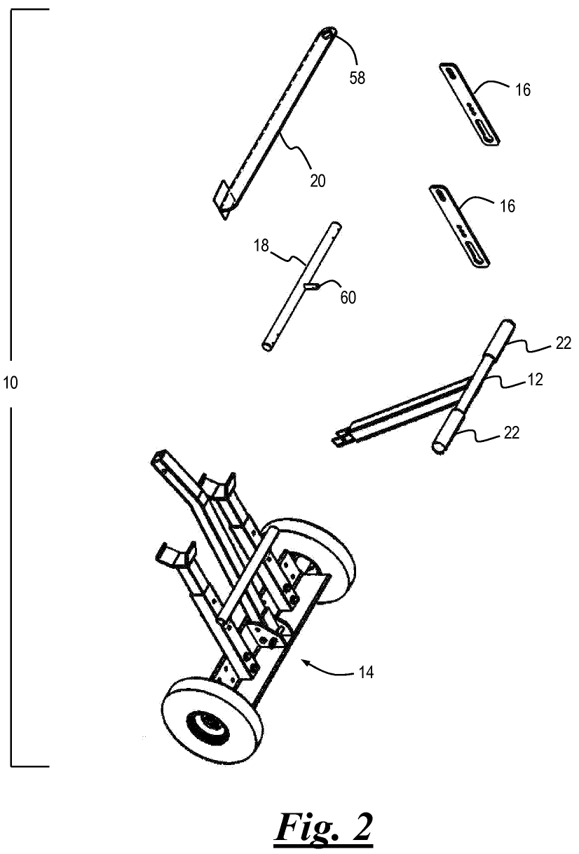

The general arrangement of a lift 10 for a lawn tractor is shown in FIGS. 1 and 2 according to an embodiment of the present invention. Lift 10 comprises a top handle 12 and a lift assembly bottom 14. A pair of mounting bars 16, a cross lift bar 18 and an elongated safety brace 20 are also used in conjunction with lift 10, as detailed below.

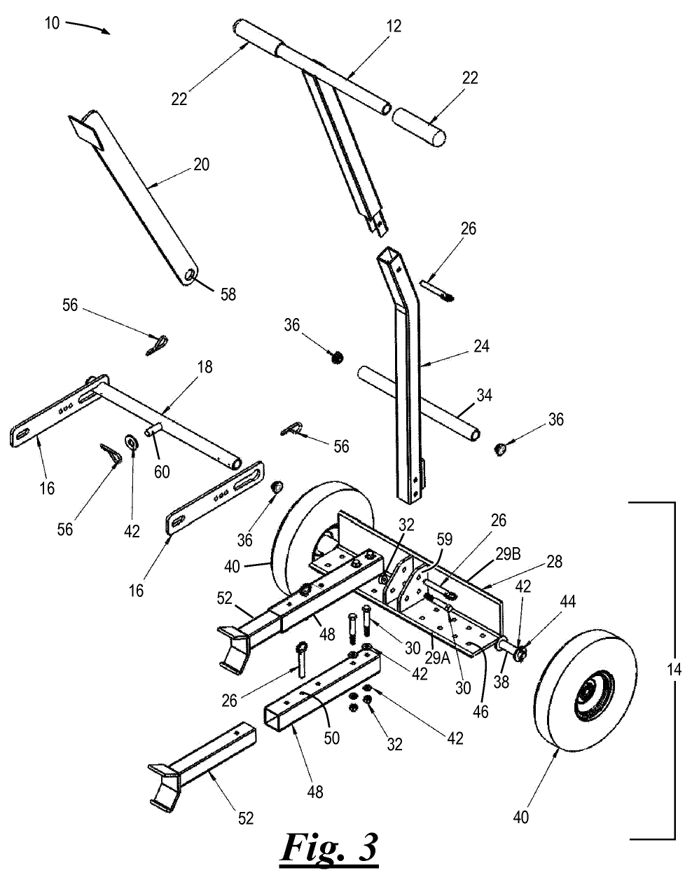

FIG. 3 is an exploded view showing further details of the components of lift 10. Top handle 12, which may include a pair of press-fit plastic, foam or rubber hand grips 22, is coupled to a bottom handle 24 of lift assembly bottom 14 and secured with a ring grip pin 26. Alternatively, top handle 12 may be secured to bottom handle 24 with a conventional threaded bolt and threaded nut. Bottom handle 24 is in turn coupled to an angle member 28 and secured with another pin 26, a bolt 30 and a nut 32. Bottom handle 24 may further include a foot brace 34 attached thereto and oriented generally perpendicularly with respect to the bottom handle. Foot brace 34 may be closed off with a set of caps 36.

Angle member 28 further includes first and second planar portions 29A, 29B forming a general “L” shape, as well as a pair of axles 38 to which corresponding wheels 40 are secured at opposing ends with a washer 42 and a cotter pin 44. A set of spaced-apart angle member holes 46 are disposed through a wall of angle member 28, to which each of a pair of receiver tubes 48 are attached with a set of bolts 30, washers 42 and nuts 32. Receiver tubes 48 each include a set of receiver tube holes 50, to which a corresponding lift member 52 is secured with a ring grip pin 26.

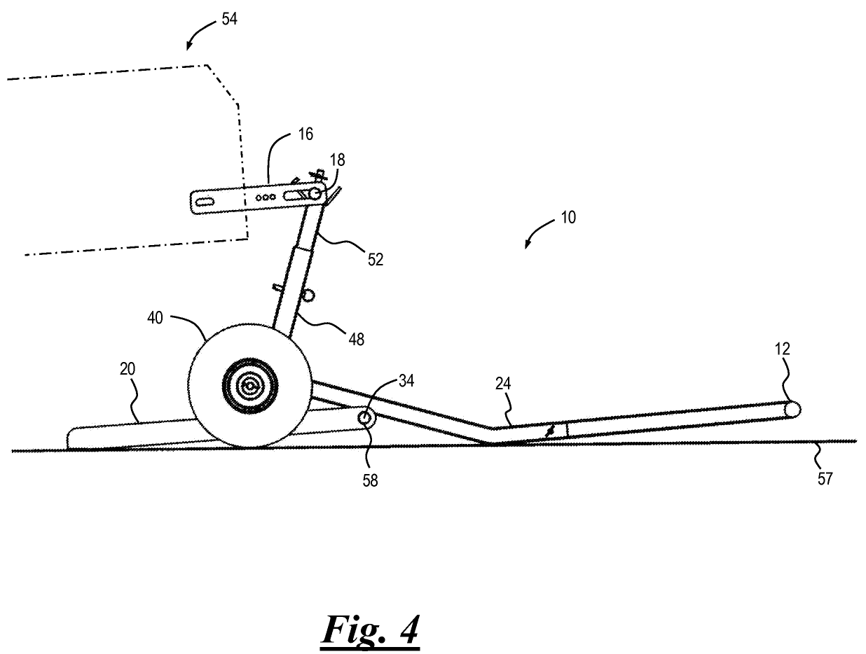

With reference now to FIGS. 3 and 4 together, mounting bars 16 are mounted to the front frame of a lawn tractor 54 (shown in phantom) and secured with conventional mounting hardware (not shown), such as, but not limited to, bolts, washers, nuts, keys and pins. Cross lift bar 18 is then inserted into spaced-apart openings in mounting bars 16 and secured thereto with a pair of corresponding “hair pin” cotter pins 56. Cross lift bar 18 may optionally include a set of caps 36 to close off the ends of the bar.

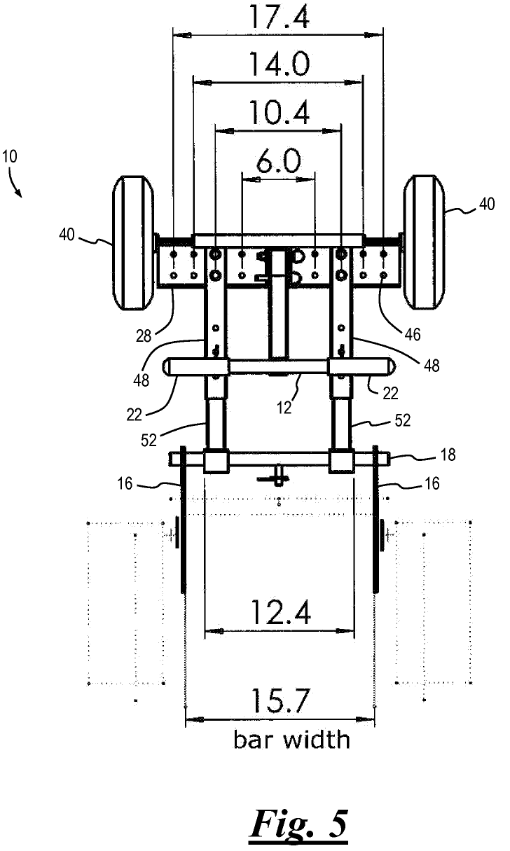

With reference to FIGS. 3, 4 and 5 in combination, lift 10 is first configured for use with lawn tractor 54 by selecting a position for receiver tubes 48 to generally outermost positions of angle member holes 46 for proper alignment of lift members 52 with respect to cross lift bar 18. Receiver tubes 48 are then secured with bolts 30, washers 42 and nuts 32 through the select angle member holes 46 and corresponding mounting holes in the receiver tubes. Likewise, lift members 52 are adjusted to select receiver tube holes 50 to achieve a desired raised height for the lawn tractor, then secured with ring grip pins 26 through the select receiver tube holes and corresponding mounting holes in the lift members. It should be noted that the dimensions shown in FIG. 5 are provided only as examples and are not intended to be limiting.

With reference to FIGS. 1 and 4 together, to lift a front end of lawn tractor 54 lift members 52 are placed into contact with cross lift bar 18. A user then places one foot on foot brace 34 and grasps upper handle 12, then moves the upper handle downwardly. This action causes angle member 28 to pivot about wheels 40, causing lift members 52 to pivot upwardly, thereby raising the front end of lawn tractor 54 off the ground. The user continues to move upper handle 12 downwardly until the handle is resting proximate the ground 57 (FIG. 4), thereby moving lift members 52 beyond the center of gravity of lawn tractor 54 such that lift 10 stably holds the lawn tractor in a raised position. The user may then orient safety brace 20 to extend under angle member 28 and lawn tractor 54, then slide an attachment end of the brace having an opening 58 onto foot brace 34. Once in place, safety brace 20 deters movement of handle 12, thereby resisting unintended lowering of lawn tractor 54. While a partially raised position, the lawn tractor may also be easily maneuvered and moved from one location to another. To lower lawn tractor 54 the user first detaches safety brace 20 from foot brace 34 by sliding the safety brace off the foot brace and sliding the safety brace out from under angle member 28 and the lawn tractor. The user then lifts handle 12 upwardly with one foot on foot brace 34, allowing lift members 52 to pivot downwardly about wheels 40, thereby lowering lawn tractor 54.

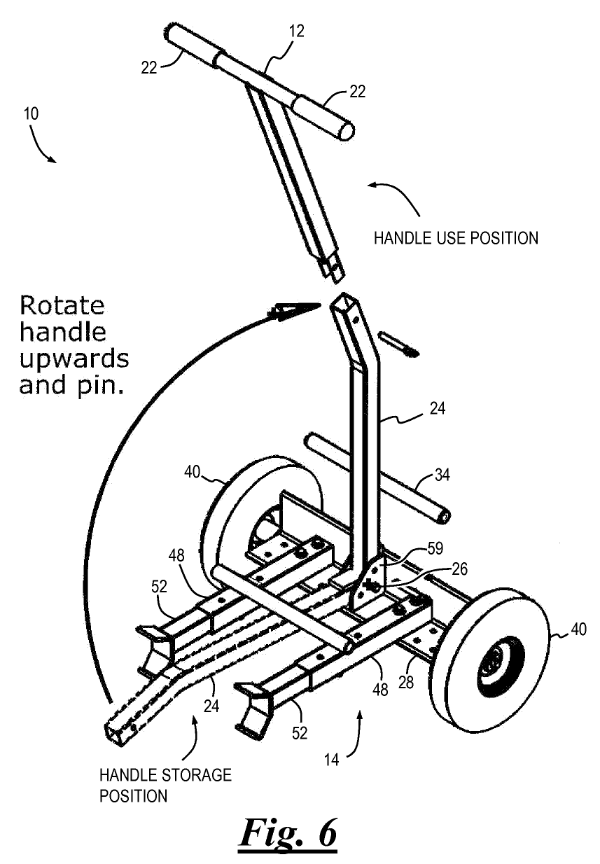

As shown in FIG. 6, a handle portion of lift 10 (comprising top handle 12 and bottom handle 24) may optionally be configured to pivot about angle member 28 between a storage position generally parallel with lift members 52 and a use position generally perpendicular to the lift members. In this embodiment angle member 28 includes a connector 59 to which bottom handle 24 is pivotally attached. Connector 59 includes aligned openings corresponding to the storage and use positions. Bottom handle 24 likewise includes a pair of aligned openings, which are in turn aligned with either the storage or use openings of connector 59. A ring grip pin 26 is removably inserted therethrough to retain the handle at the desired position.

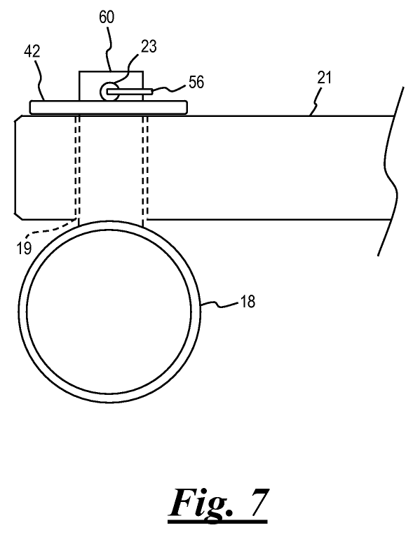

With reference again to FIGS. 3 and 7, in another optional embodiment of the present invention cross lift bar 18 may be attached to a rear hitch of a lawn tractor by placing the cross lift bar beneath an opening 19 in a rear-mounted accessory hitch 21 of a lawn tractor such that a projecting member 60 of the cross lift bar extends upwardly through the opening. Cross lift bar 18 is then secured to rear accessory hitch 21 with a washer 42 and a hair pin cotter pin 56 coupled to an aperture 23 of projecting member 60 that is positioned above the accessory hitch opening. Alternatively, projecting member 60 may be threaded, in which case cross lift bar 18 is secured to rear accessory hitch 21 with a conventional threaded nut (not shown) that is threaded onto the projecting member in place of hair pin cotter pin 56. In operation, the rear end of the lawn tractor may be raised and lowered in the same manner as described above for lifting a front end of the lawn tractor and thus will not be reiterated here. While in a partially raised position, the lawn tractor 54 may also be easily maneuvered and moved from one location to another.

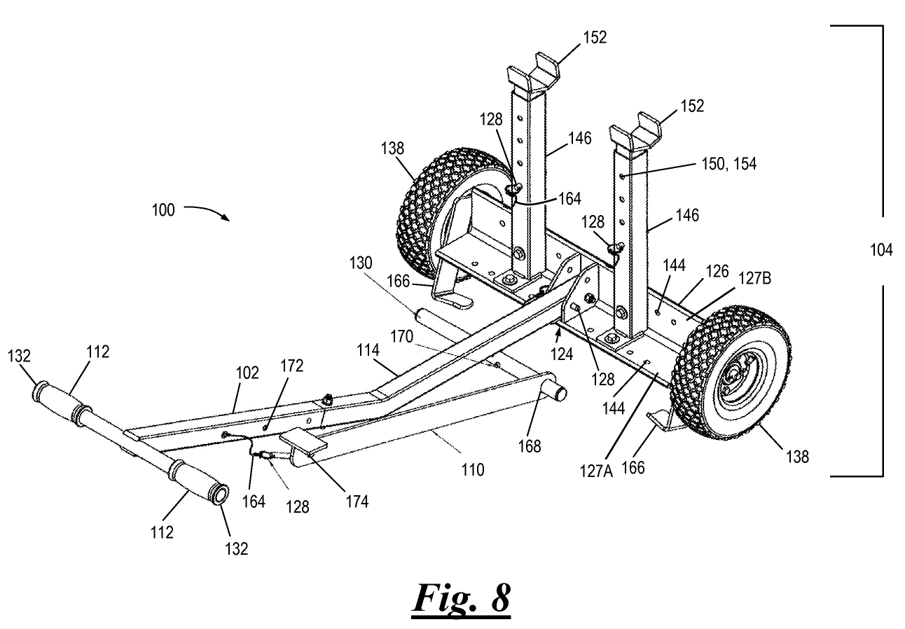

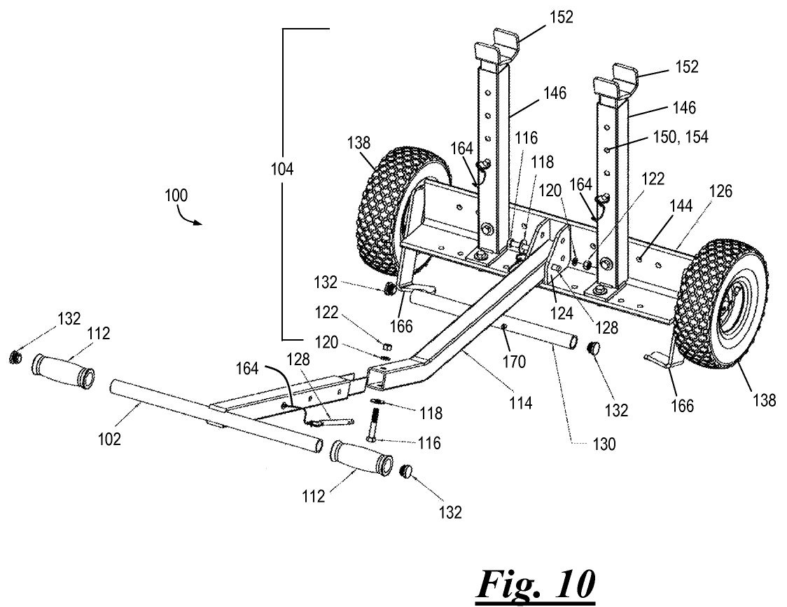

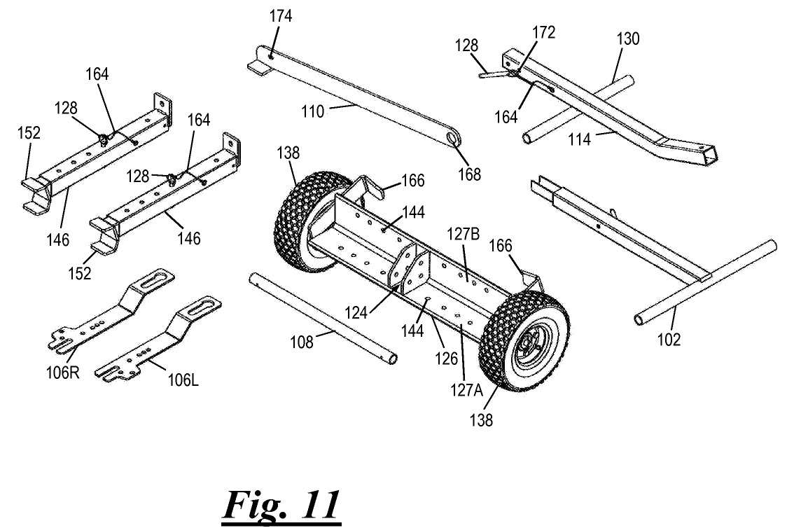

The general arrangement of a lawn tractor lift 100 is shown in FIGS. 8 through 15 according to another embodiment of the present invention. Lift 100 comprises a handle top portion 102 and a lift assembly 104. A pair of mounting bars 106L, 106R, a cross lift bar 108 and an elongated safety brace 110 may also be used in conjunction with lift 100, as detailed below.

FIGS. 8 through 11 are views showing further details of the components and assembly of lift 100. Handle top portion 102, which may include a pair of press-fit plastic, foam or rubber hand grips 112, is coupled to a handle bottom portion 114 of lift assembly 104 and secured with a threaded bolt 116, a flat washer 118, a lock washer 120 and a threaded nut 122. Alternatively, a conventional ring grip pin (not shown) may be used. Handle bottom portion 114 is in turn coupled to a connector 124 of an angle member 126 and secured thereto with a ring grip pin 128, a threaded bolt 116, a flat washer 118, a lock washer 120 and a threaded nut 122. Handle bottom portion 114 may further include a foot brace 130 attached thereto and oriented generally perpendicularly with respect to the handle bottom portion. The ends of foot brace 130 may be closed off with a set of cap plugs 132, as may handle top portion 102. A scuff pad 134 may be attached to handle bottom portion 114 to deter marring of the handle bottom portion when in contact with the ground.

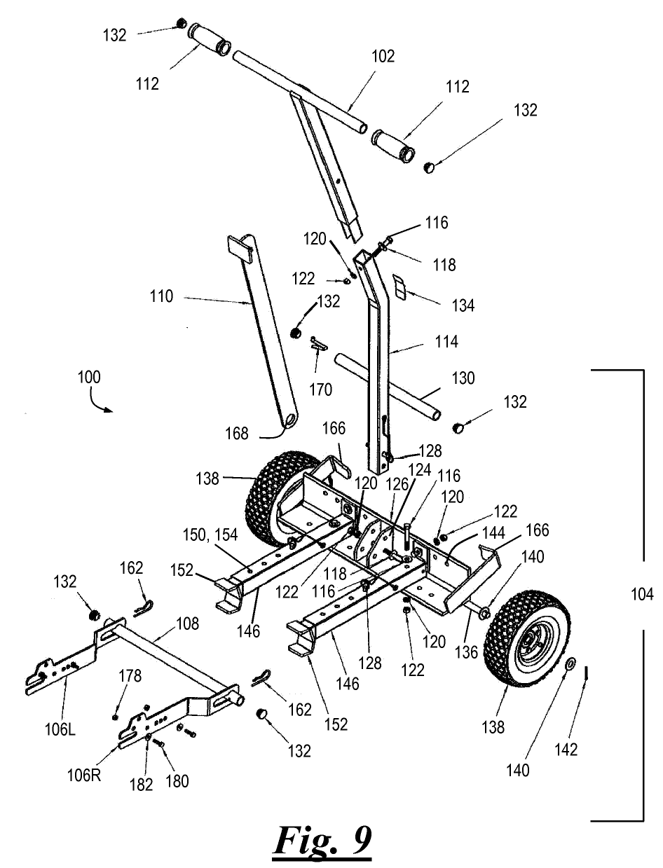

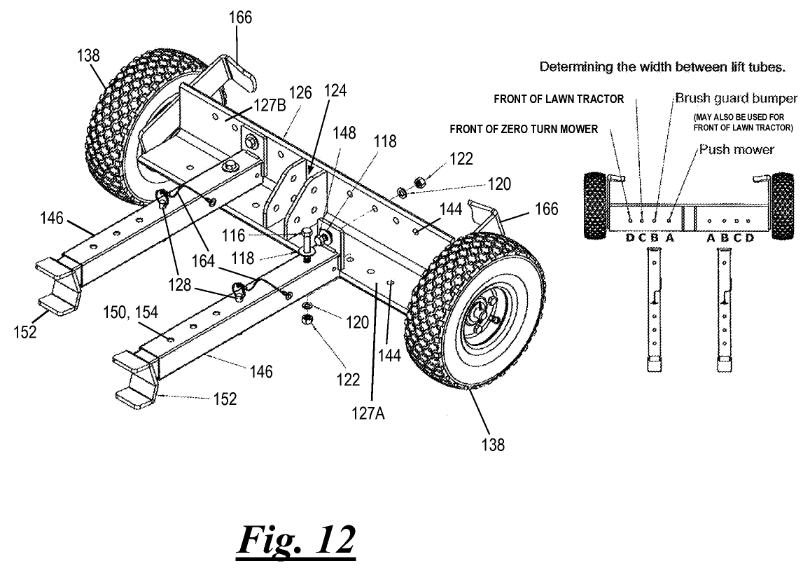

Angle member 126 further includes first and second planar portions 127A, 127B forming a general “L” shape, as well as one or more axles 136, to which a pair of tired wheels 138 are secured with one or more flat washers 140 and a cotter pin 142 (FIG. 9). With additional reference to FIG. 12, a set of spaced-apart angle member holes 144 are disposed through the walls of angle member 126, to which each of a pair of receiver tubes 146 are attached with a set of threaded bolts 116, 148, flat washers 118, lock washers 120 and threaded nuts 122. Receiver tubes 146 each include a set of receiver tube holes 150, to which a corresponding lift member 152 is secured through corresponding holes 154 with a set of ring grip pins 128.

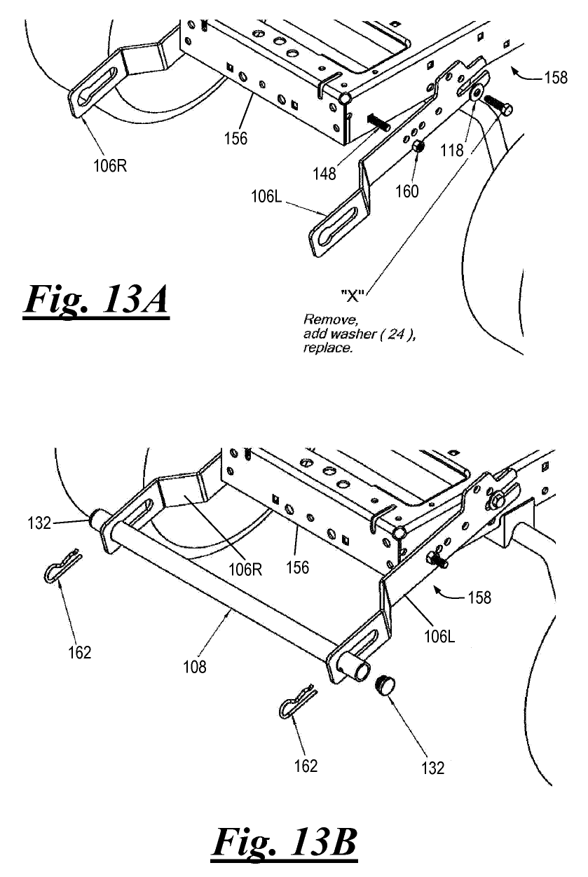

With reference now to FIGS. 13A and 13B, mounting bars 106L, 106R are mounted to a front frame 156 of a lawn tractor 158 and secured with conventional mounting hardware such as, but not limited to, threaded bolts 148, flat washers 118 and threaded locking nuts 160, as well as conventional key and pin fasteners. Cross lift bar 108 is then inserted into spaced-apart openings in mounting bars 106L, 106R and secured thereto with a pair of corresponding hair pin cotter pins 162. Cross lift bar 108 may optionally include a set of cap plugs 132 to close off the ends of the bar. It should be noted that mounting bars 106L, 106R and cross lift bar 108 may be omitted for some configurations of lawn tractor 158. In such configurations lift members 152 directly engage corresponding portions of the frame of the lawn tractor.

With reference to FIGS. 8, 9, 10, 12, 13A and 13B in combination, lift 100 is first configured for use with lawn tractor 158 by selecting angle member 126 holes 144 for receiver tubes 146 such that lift members 152 will be located at outermost positions of cross lift bar 108 (i.e., proximate but between mounting bars 106L, 106R) when engaged thereto. Receiver tubes 146 are secured to angle member 126 with threaded bolts 116, 148, flat washers 118, lock washers 120 and threaded nuts 122 through the select angle member holes 144. Likewise, lift members 152 are slidably adjusted into corresponding receiver tubes 146 to select receiver tube holes 150 to achieve a desired raised height for the lawn tractor, then secured with ring grip pins 128 through the select receiver tube holes 150 and corresponding mounting holes 154 in the lift members. If desired, ring grip pins 128 may be secured to receiver tubes 146 with lanyards 164 (FIG. 8) to prevent them from loss.

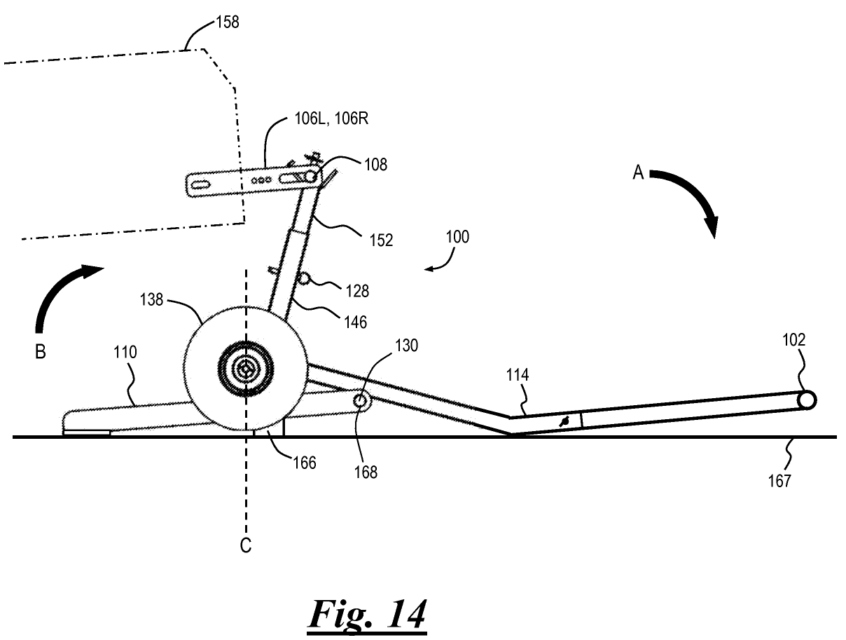

With reference to FIGS. 8 and 14, to lift a front end of a lawn tractor 158 lift members 152 are placed underneath and into contact with cross lift bar 108 (or directly into contact with corresponding portions of the frame of the lawn tractor, for lawn tractors so configured). A user then places one foot on foot brace 130 and grasps handle top portion 102, and moves the handle top portion downwardly in general direction “A.” This action causes lift members 152 to pivot about wheels 138, upwardly in general direction “B,” thereby raising the front end of lawn tractor 158 off the ground. The user continues to move handle top portion 102 downwardly until a pair of support legs 166 of angle member 126 come into contact with the ground, thereby raising wheels 138 off the ground and moving lift members 152 beyond the center of gravity “C” of lift 100 such that the lift stably holds the lawn tractor in an elevated position. The user may then orient safety brace 110 to extend under lawn tractor 158 and angle member 126, and slide an attachment end of the brace having an opening 168 onto foot brace 130. Once connected to foot brace 130, the attachment end of brace 110 is preferably slidably moved toward handle bottom portion 114 and past a biased snap button 170 (FIG. 8), thereby retaining the attachment end of the brace between the snap button and the handle bottom portion. Once in place, safety brace 110 deters vertical movement of handle portions 102, 114, thereby resisting unintended lowering of lawn tractor 158. To lower lawn tractor 158 the user first detaches safety brace 110 from foot brace 130 by sliding the safety brace past snap button 170 and off the foot brace. The user then lifts handle 102, 114 upwardly with one foot on foot brace 130, allowing lift members 152 to pivot downwardly about wheels 138, thereby lowering lawn tractor 158.

With reference to FIG. 8, when not in use lift 100 may be folded for storage by removing the ring grip pin 128 retaining handle lower portion 114 to connector 124 and pivoting the handle about bolt 116 and the connector until the handle is generally parallel to receiver tubes 146. Ring grip pin 128 may then be reinstalled into aligned holes in connector 124 and handle lower portion 114, thereby retaining the handle in the storage position. Likewise, a ring grip pin 128 may be inserted into aligned openings 172, 174 in handle upper portion 102 and safety brace 110, respectively, to retain the safety brace. This ring grip pin 128 may be secured to handle upper portion 102 with a lanyard 164, if desired.

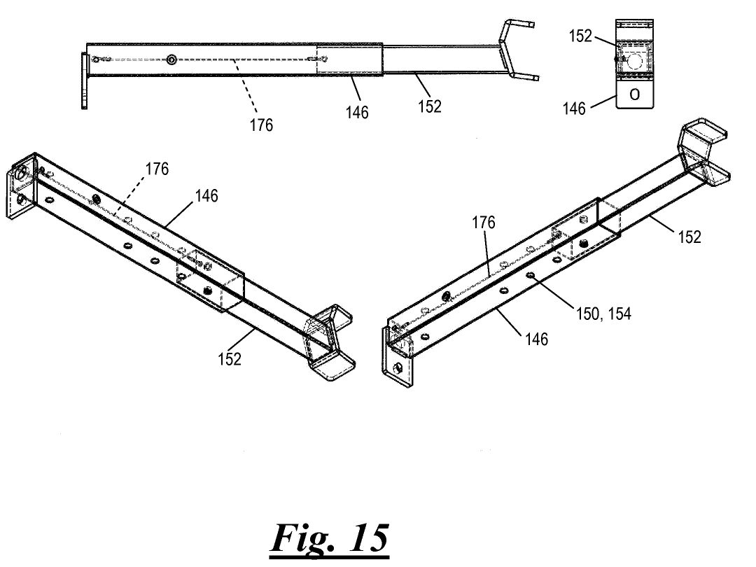

With reference to FIG. 15, in one embodiment of the present invention receiver tubes 146 and corresponding lift members 152 may be tethered together with a tether 176. Tether 176 limits the slidable travel of lift member 152 with respect to receiver tube 146, thereby preventing them from being separated while still allowing for adjustment of holes 150, 154 of the receiver tube and lift member holes, respectively.

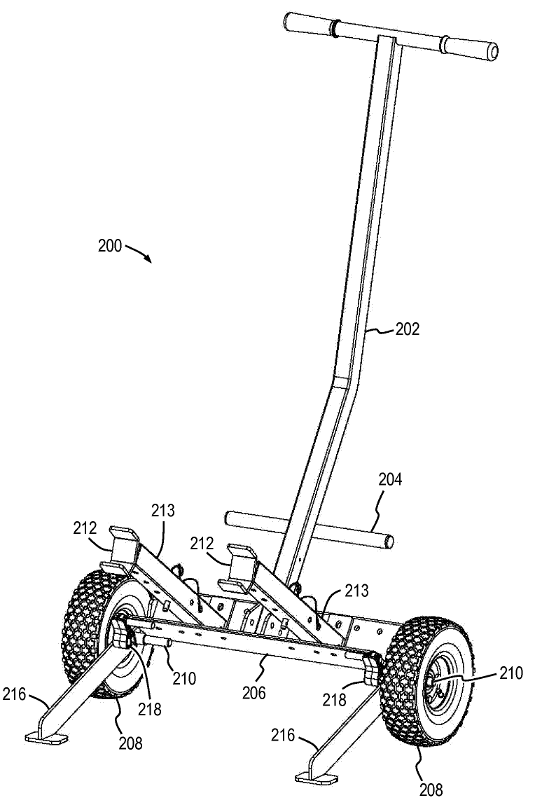

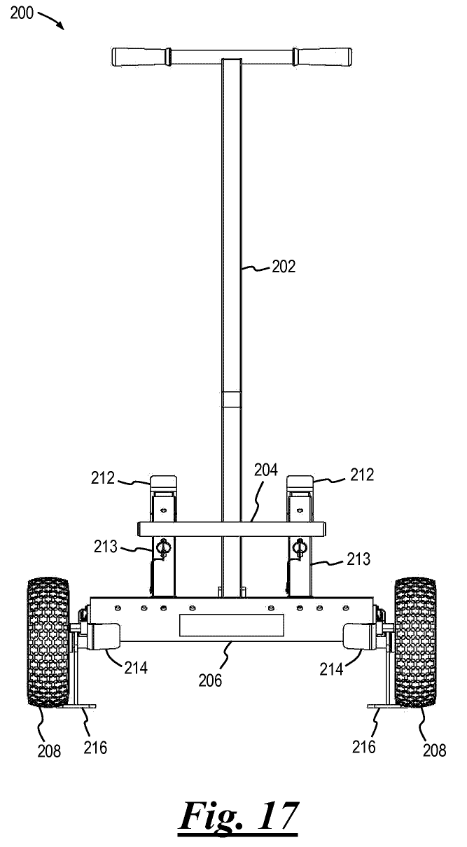

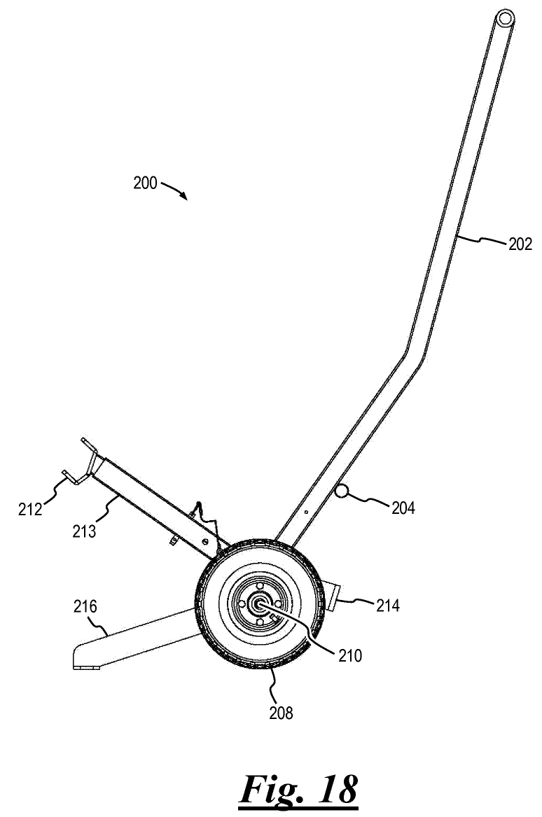

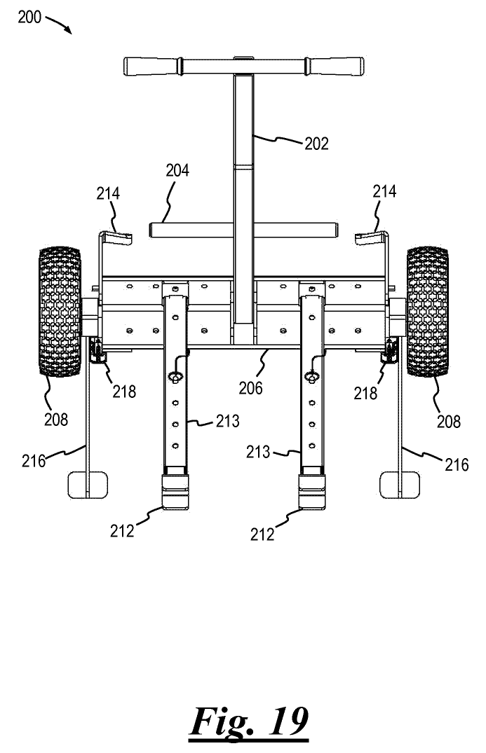

The general arrangement of a lift 200 for a lawn tractor is shown in FIGS. 16 through 23 according to yet another embodiment of the present invention. Lift 200 comprises a handle 202 having a foot brace 204 attached and oriented generally perpendicularly thereto. Handle 202 is attached to an angle bracket 206, along with a pair of wheels 208 that are mounted to opposing ends of the angle bracket and rotatably coupled to one or more axles 210. A pair of lift members 212 and receiver tubes 213 are detachably and adjustably attached to angle bracket 206.

Except as detailed below, lift 200 is similar to lifts 10, 100 in operation. With reference to FIGS. 16-18, to lift a lawn tractor (such as lawn tractor 158 in FIG. 14), lift members 212 are placed into contact with a complementary cross lift bar (such as cross lift bar 108 of FIG. 14) attached to the lawn tractor. Alternatively, lift members 212 may directly engage an appropriate portion of the frame of the lawn tractor. A user then places one foot on foot brace 204 and grasps handle 202, then moves the handle downwardly. This action causes angle bracket 206 to pivot about wheels 208, in turn causing lift members 212 to pivot upwardly, thereby raising the lawn tractor off the ground. The user continues to move handle 202 downwardly until a pair of legs 214 attached to angle bracket 206 come into contact with the ground, thereby raising wheels 208 off the ground and moving lift members 212 beyond the center of gravity of the lawn tractor such that lift 200 stably holds the lawn tractor in a raised position.

With reference to FIGS. 16 through 23 together, in some embodiments lift 200 may include a pair of stabilizers 216 that are rotatably coupled to angle bracket 206 and pivot with respect to the angle bracket. Stabilizers 216 rotate freely such that they easily fall to the ground due to the force of gravity. A corresponding pair of safety locks 218, which are also rotatably coupled to angle bracket 206, likewise hang freely towards the ground due to the force of gravity.

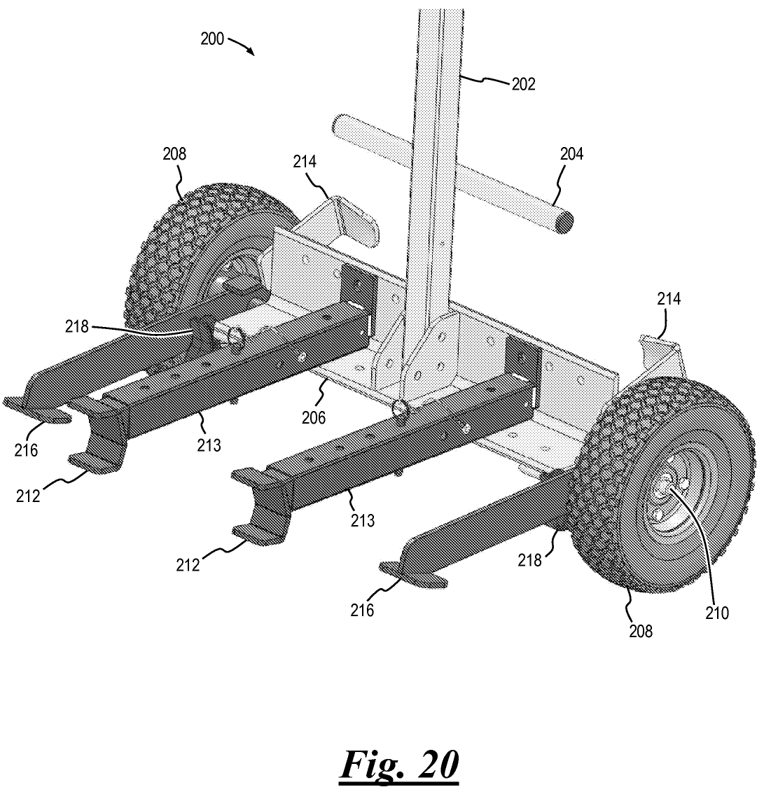

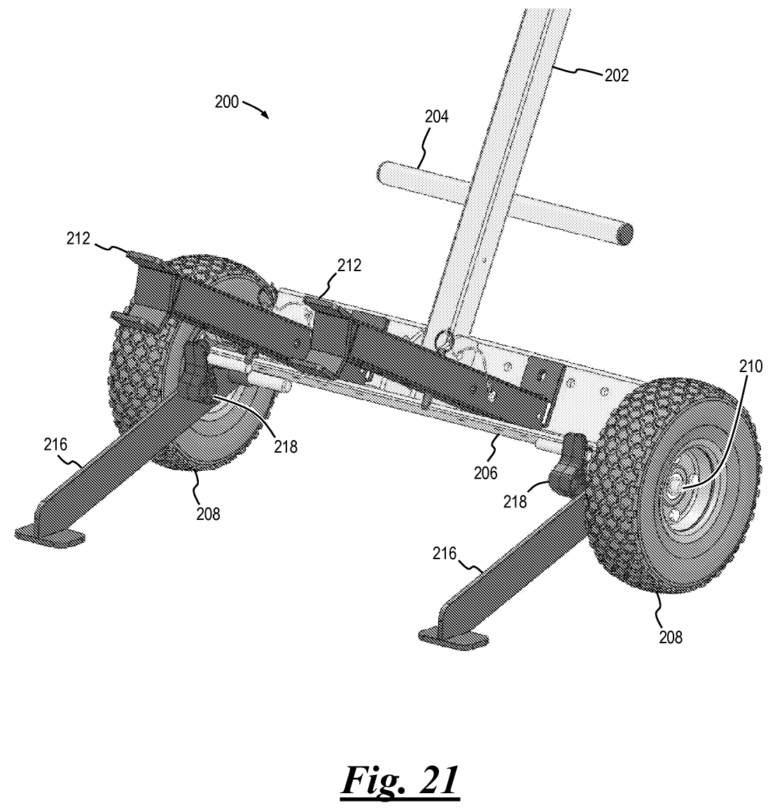

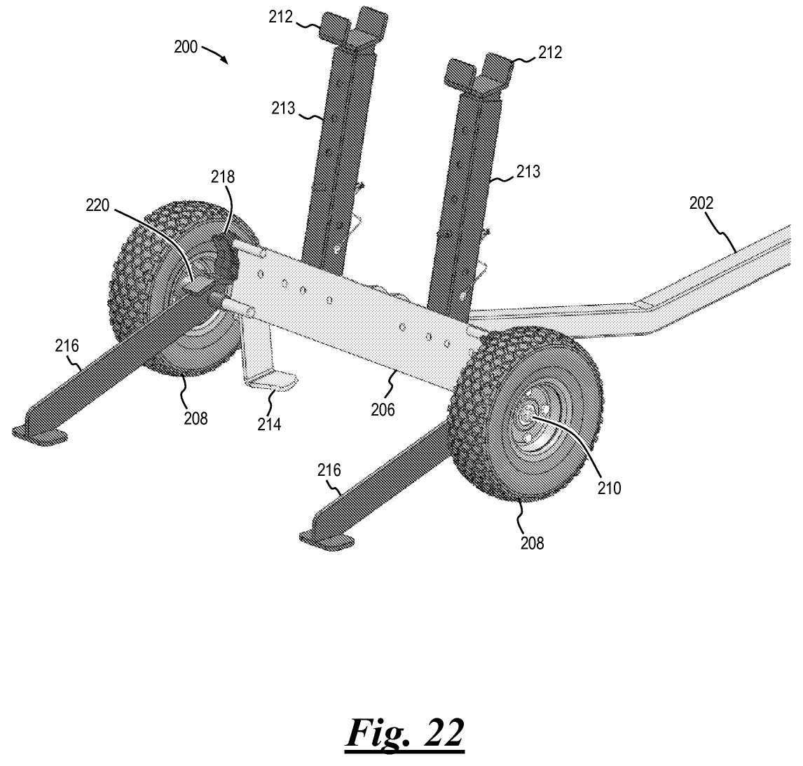

In operation, to lift a lawn tractor a user rotates handle 202 downwardly in the manner previously described, stabilizers 216 remaining generally in contact with the ground as angle bracket 206 pivots about axle 210 (FIGS. 20 and 21). As angle bracket 206 pivots safety locks 218 move up and over a contacting surface 220 of corresponding stabilizers 216, resting proximate the angle bracket (FIG. 22). In this position, if an attempt is made to lift handle 202 the safety locks 218 will engage the stabilizers 216 to resist said lifting.

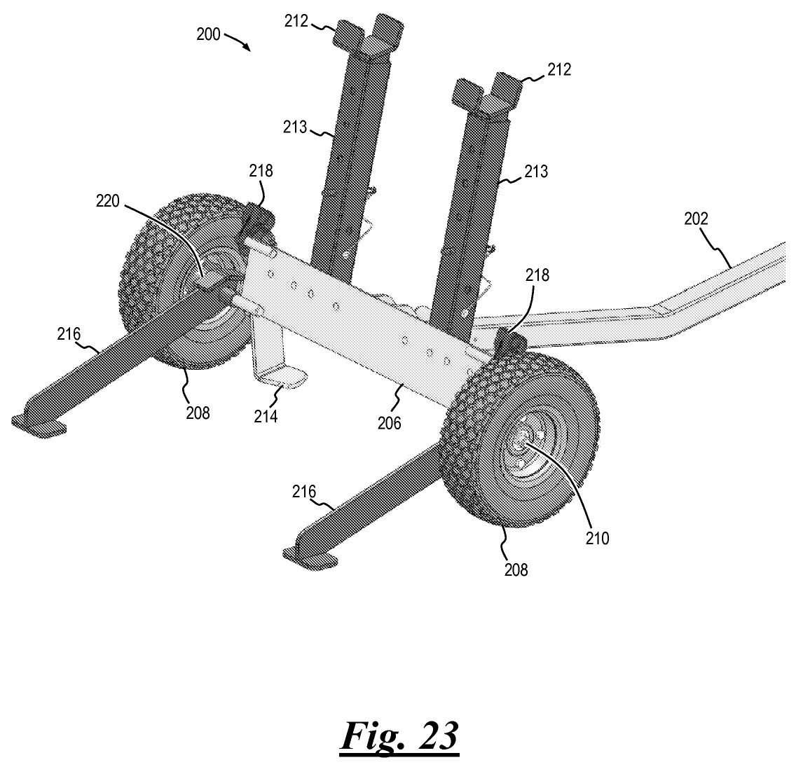

To lower lift 200 a user first rotates each safety lock 218 away from the corresponding stabilizer 216 (FIG. 23). The safety locks 218 are thus disengaged from stabilizers 216, allowing handle 202 to be lifted to lower the lawn tractor. As the lawn tractor is lowered safety locks 218 rotate back to the starting position due to the force of gravity (FIG. 20), thereby resetting the safety locks for engaging stabilizers 216 when handle 202 is subsequently lowered to raise a lawn tractor to a service position in the manner previously described.

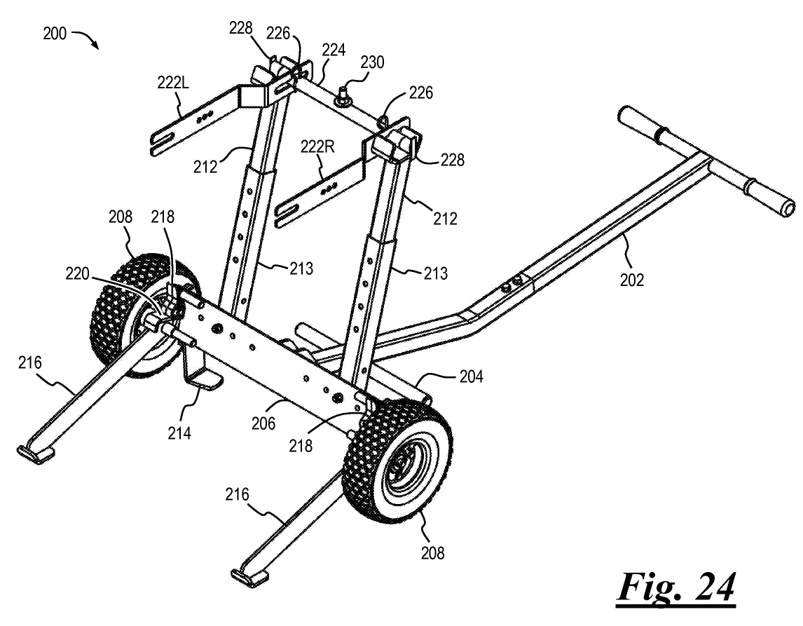

With reference now to FIG. 24, in yet another embodiment of the present invention a set of mounting bars 222L, 222R may be mounted to a front frame of a lawn tractor (such as lawn tractor 158 in FIGS. 13A, 13B) and secured with conventional mounting hardware such as, but not limited to, threaded bolts, flat washers and threaded locking nuts, as well as conventional key and pin fasteners. A cross lift bar 224 is then inserted into spaced-apart openings in mounting bars 222L, 222R and secured thereto with a pair of corresponding hair pin cotter pins 226. Cross lift bar 224 may also include a set of tabs 228 at each end. As can be seen from FIG. 24, lift members 212 may engage cross lift bar 224 in the regions between mounting bars 222L, 222R and the tab 228 proximate each mounting bar, the mounting bars and tabs together deterring lateral movement of the lift members along the longitudinal axis of the cross lift bar. It should be noted that mounting bars 222L, 222R and cross lift bar 224 may be omitted for some configurations of lawn tractor 158. In such configurations lift members 212 directly engage corresponding portions of the frame of the lawn tractor.

With continued reference to FIG. 24, in another optional embodiment of the present invention cross lift bar 224 may be attached to a rear hitch of a lawn tractor by placing the cross lift bar beneath an opening in a rear-mounted accessory hitch of a lawn tractor such that a projecting member 230 of the cross lift bar extends upwardly through the opening. Cross lift bar 224 is then secured to the rear accessory hitch in a manner similar to that shown in FIG. 7 and detailed above. Alternatively, projecting member 230 may be threaded, in which case cross lift bar 224 is secured to the rear accessory hitch with a washer and a conventional threaded nut (not shown) that is threaded onto the projecting member in place of the hair pin cotter pin 56 of FIG. 7.

While this invention has been shown and described with respect to a detailed embodiment thereof, it will be understood by those skilled in the art that changes in form and detail thereof may be made without departing from the scope of the claims of the invention.

What is claimed is:

1. A lifting device for a lawn tractor, comprising:
an angle member having first and second generally planar portions, the second planar portion being oriented generally perpendicularly and joined to the first planar portion;
a pair of wheels rotatably attached to opposing ends of the angle member;
a handle extending from the first planar portion of the angle member;
a foot brace attached to the handle and oriented generally perpendicularly thereto;
a pair of spaced-apart lift members extending from the second planar portion of the angle member; and
an elongated safety brace having an opening proximate an end, the opening being configured to fit slidably over the foot brace to detachably couple the safety brace to the foot brace, the safety brace being positionable to extend beneath the angle member while coupled to the foot brace and while the lifting device is in a service position to resist movement of the lift from the service position.

2. The lifting device of claim 1 wherein the lift members are adjustably attached to the angle member to adjust their spacing.

3. The lifting device of claim 1 wherein each of the lift members further comprise a receiver tube to which the lift member is adjustably attached to adjust the height to which the lift member extends from the angle member.

4. The lifting device of claim 1 wherein the handle is pivotably attached to the angle member and is selectably fixable at one of a use position and a storage position.

5. The lifting device of claim 1, further comprising:
a pair of spaced-apart mounting bars configured to be attached to a lawn tractor; and
a cross lift bar extending between the mounting bars, wherein the cross lift bar is engageable by the lift members to couple the lifting device to the lawn tractor.

6. The lifting device of claim 1, further comprising a cross lift tube having a projecting member, the projecting member being adapted to be secured to a rear accessory hitch of the lawn tractor.

7. A lifting device for a lawn tractor, comprising:
an angle member having first and second generally planar portions, the second planar portion being oriented generally perpendicularly and joined to the first planar portion;
a pair of wheels rotatably attached to opposing ends of the angle member;
a handle extending from the first planar portion of the angle member;
a foot brace attached to the handle and oriented generally perpendicularly thereto;
a pair of spaced-apart lift members extending from the second planar portion of the angle member;
a pair of support legs attached to opposing ends of the angle member, the support legs being configured to move the wheels away from a contacting surface when the lift is in a service position; and
an elongated safety brace having a first opening proximate an end, the first opening being configured to fit slidably over the foot brace to detachably couple the safety brace to the foot brace, the safety brace being positionable to extend beneath the angle member while coupled to the foot brace and while the lifting device is in a service position, to resist movement of the lift from the service position.

8. The lifting device of claim 7 wherein the lift members are adjustably attached to the angle member to adjust their spacing.

9. The lifting device of claim 7 wherein each of the lift members further comprise a receiver tube to which the lift member is adjustably attached to adjust the height to which the lift member extends from the angle member.

10. The lifting device of claim 9, further comprising a tether extending between the receiver tube and the lift member.

11. The lifting device of claim 7, further comprising:
a pair of spaced-apart mounting bars configured to be attached to a lawn tractor; and
a cross lift bar extending between the mounting bars, wherein the cross lift bar is engageable by the lift members to couple the lifting device to the lawn tractor.

12. The lifting device of claim 7, further comprising:
a brace ring grip pin attached to the handle with a lanyard;
an opening formed in the handle; and
a second opening proximate an opposing end of the safety brace, the second opening being configured to detachably receive the brace ring grip pin,
wherein the safety brace is stored by coupling the first opening of the safety brace to the foot brace and aligning the second opening of the safety brace with the handle opening, then inserting the brace ring grip pin through the aligned openings.

13. The lifting device of claim 12, further comprising a biased snap button to selectably secure the safety brace to the foot brace.

14. A lifting device for a lawn tractor, comprising:
an angle member having first and second generally planar portions, the second planar portion being oriented generally perpendicularly and joined to the first planar portion;
a pair of wheels rotatably attached to opposing ends of the angle member;
a handle extending from the first planar portion of the angle member;
a foot brace attached to the handle and oriented generally perpendicularly thereto;
a pair of spaced-apart lift members extending from the second planar portion of the angle member;
a pair of spaced-apart stabilizers rotatably coupled to the second planar portion of the angle member; and
a pair of safety locks rotatably coupled to the second planar portion of the angle member, each safety lock being positioned proximate a stabilizer and configured to engage the stabilizer when the lift is in a service position to resist movement of the lift from the service position.

15. The lifting device of claim 14 wherein the lift members are adjustably attached to the angle member to adjust their spacing.

16. The lifting device of claim 14 wherein each of the lift members further comprise a receiver tube to which the lift member is adjustably attached to adjust the height to which the lift member extends from the angle member.

17. The lifting device of claim 16, further comprising a receiver ring grip pin attached to the receiver tube with a lanyard, the receiver ring grip pin being configured to fit into aligned openings in the lift member and the receiver tube to detachably join together the lift member and the receiver tube.

18. The lifting device of claim 14 wherein the handle is pivotably attached to the angle member and is selectably fixable at one of a use position and a storage position.

19. The lifting device of claim 14, further comprising:
a pair of spaced-apart mounting bars configured to be attached to a lawn tractor; and
a cross lift bar extending between the mounting bars, wherein the cross lift bar is engageable by the lift members to couple the lifting device to the lawn tractor.

20. The lifting device of claim 14, further comprising a cross lift bar having a projecting member, the projecting member being adapted to be secured to a rear accessory hitch of the lawn tractor.
